(19) United States
(12) Patent Application Publication
(10) Pub. No.: US 2025/0055372 A1
(43) Pub. Date: Feb. 13, 2025

(54) POWER CONVERSION SYSTEM WITH FAST REGULATION SPEED AND ASSOCIATED CONTROL CIRCUIT AND CONTROL METHOD

(71) Applicant: Chengdu Monolithic Power Systems Co., Ltd., Chengdu (CN)

(72) Inventors: Pengfei Liu, Hangzhou, Zhejiang (CN); Hao Wang, Hangzhou, Zhejiang (CN); Chuanhao Xu, Hangzhou, Zhejiang (CN)

(21) Appl. No.: 18/796,011

(22) Filed: Aug. 6, 2024

(30) Foreign Application Priority Data
Aug. 7, 2023 (CN) 202310991036.X

(51) Int. Cl. H02M 3/158; H02M 1/00

(52) U.S. Cl. CPC H02M 3/158; H02M 1/0025

(57) ABSTRACT

A control circuit for a power conversion system having a first-stage power conversion circuit and a second-stage power conversion circuit is provided. The control circuit includes a compensation control circuit and a pre-stage control circuit. The compensation control circuit receives a first feedback signal and a second feedback signal and provides a compensation control signal based on the first feedback signal and the second feedback signal. The first feedback signal indicates a first output voltage provided by the first-stage power conversion circuit. The second feedback signal indicates a second output voltage provided by the second-stage power conversion circuit. The pre-stage control circuit receives the compensation control signal and provides a switching control signal based on the compensation control signal. The switching control signal controls a main switch of the first-stage power conversion circuit.

### CROSS-REFERENCE TO RELATED APPLICATIONS

This application claims the benefit of CN application No. 202310991036.X, filed on Aug. 7, 2023, and incorporated herein by reference.

### TECHNICAL FIELD OF THE INVENTION

The present invention generally relates to electronic circuits, and more particularly but not exclusively, to a control circuit for a power conversion system and an associated control method.

### BACKGROUND OF THE INVENTION

In the field of power converters, multi-stage power conversion systems are widely used to improve system efficiency while accommodating different load requirements. The multi-stage power conversion system typically includes a plurality of power conversion circuits and their respective control circuits. The plurality of power conversion circuits could have different topologies. In particular, for an AC-DC power system, it is common to have a first-stage power conversion circuit for converting an AC input voltage to a DC voltage, and a second-stage power conversion circuit for converting the DC voltage provided by the first-stage power conversion circuit to an output voltage suitable for a load. In common applications, the first-stage power conversion circuit and the second-stage power conversion circuit are controlled by different control circuits, which cooperate with each other to convert the AC input voltage to the suitable output voltage.

In the multi-stage power conversion system, when the load varies, the regulation speed of the multi-stage power conversion system is slow, which leads to large fluctuations of the output voltage.

### SUMMARY OF THE INVENTION

An embodiment of the present invention discloses a control circuit for a power conversion system having a first-stage power conversion circuit and a second-stage power conversion circuit. The control circuit includes a compensation control circuit and a pre-stage control circuit. The compensation control circuit receives a first feedback signal and a second feedback signal and provides a compensation control signal based on the first feedback signal and the second feedback signal. The first feedback signal indicates a first output voltage provided by the first-stage power conversion circuit. The second feedback signal indicates a second output voltage provided by the second-stage power conversion circuit. The pre-stage control circuit receives the compensation control signal and provides a switching control signal based on the compensation control signal. The switching control signal controls a main switch of the first-stage power conversion circuit.

Another embodiment of the present invention discloses a power conversion system. The power conversion system includes a first-stage power conversion circuit, a second-stage power conversion circuit and a control circuit. The first-stage power conversion circuit receives an input voltage and provides a first output voltage based on the input voltage. The second-stage power conversion circuit receives the first output voltage and provides a second output voltage based on the first output voltage. The control circuit includes a compensation control circuit and a pre-stage control circuit. The compensation control circuit receives a first feedback signal indicating the first output voltage and a second feedback signal indicating the second output voltage and provides a compensation control signal based on the first feedback signal and the second feedback signal. The pre-stage control circuit receives the compensation control signal and provides a switching control signal based on the compensation control signal. The switching control signal controls a main switch of the first-stage power conversion circuit.

Yet another embodiment of the present invention discloses a control method for a power conversion system having a first-stage power conversion circuit and a second-stage power conversion circuit. A first feedback signal indicating a first output voltage provided by the first-stage power conversion circuit is received. A second feedback signal indicating a second output voltage provided by the second-stage power conversion circuit is received. A compensation control signal is provided based on the first feedback signal and the second feedback signal. A switching control signal is provided based on the compensation control signal to control a main switch of the first-stage power conversion circuit.

### BRIEF DESCRIPTION OF DRAWINGS

The present invention can be further understood with reference to the following detailed description and the appended drawings, wherein like elements are provided with like reference numerals.

FIG. 1 shows a block circuit diagram of a conventional two-stage power conversion system 10.

FIG. 2 shows a schematic diagram of a power conversion system 20 in accordance with an embodiment of the present invention.

FIG. 3 shows a schematic diagram of a power conversion system 30 in accordance with an embodiment of the present invention.

FIG. 4 shows a schematic diagram of a feedback control circuit 40 in accordance with an embodiment of the present invention.

FIG. 5 shows a schematic diagram of a feedback control circuit 50 in accordance with an embodiment of the present invention.

FIG. 6 shows working waveforms of the power conversion system 30 in accordance with an embodiment of the present invention.

FIG. 7 shows a schematic diagram of a feedback control circuit 70 in accordance with an embodiment of the present invention.

FIG. 8 shows a schematic diagram of a compensation control circuit 80 in accordance with an embodiment of the present invention.

FIG. 9 shows a schematic diagram of a compensation control circuit 90 in accordance with an embodiment of the present invention.

FIG. 10 shows a flow diagram of a control method 100 for a power conversion system in accordance with an embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Reference to “one embodiment”, “an embodiment”, “an example” or “examples” means: certain features, structures, or characteristics are contained in at least one embodiment of the present invention. These “one embodiment”, “an embodiment”, “an example” and “examples” are not necessarily directed to the same embodiment or example. Furthermore, the features, structures, or characteristics may be combined in one or more embodiments or examples. In addition, it should be noted that the drawings are provided for illustration and are not necessarily to scale. And when an element is described as “connected” or “coupled” to another element, it can be directly connected or coupled to the other element, or there could exist one or more intermediate elements. In contrast, when an element is referred to as “directly connected” or “directly coupled” to another element, there is no intermediate element.

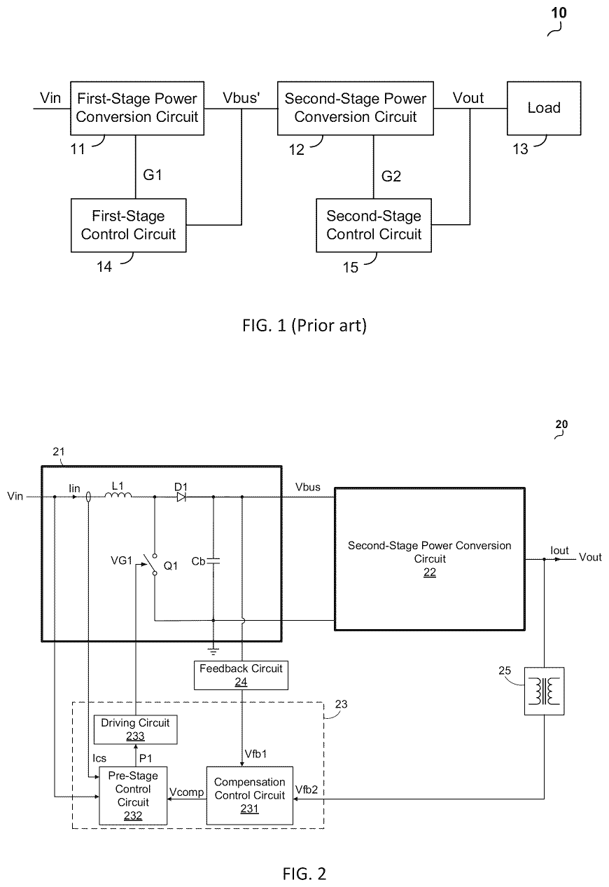

FIG. 1 shows a block circuit diagram of a conventional two-stage power conversion system 10. The two-stage power conversion system 10 converters an input voltage Vin to an output voltage Vout to power a load 13. As shown in FIG. 1, the two-stage power conversion system 10 includes a first-stage power conversion circuit 11 and a second-stage power conversion circuit 12. The first-stage power conversion circuit 11 receives the input voltage Vin and converts the input voltage Vin to an intermediate voltage Vbus′, and provides the intermediate voltage Vbus' to the second-stage power conversion circuit 12. The second-stage power conversion circuit 12 receives the intermediate voltage Vbus' and converts the intermediate voltage Vbus' to the output voltage Vout, and provides the output voltage Vout to the load 13. As shown in FIG. 1, the two-stage power conversion system 10 further includes a first-stage control circuit 14 and a second-stage control circuit 15 to control the first-stage power conversion circuit 11 and the second-stage power conversion circuit 12, respectively.

In some applications, the load 13 may increase transiently, resulting in a transient undershoot at the output voltage Vout. When the second-stage control circuit 15 detects the drop of the output voltage Vout, it controls the second-stage power conversion circuit 12 to draw more energy from the first-stage power conversion circuit 11, to ensure the energy requirement of the load 13. Thus, the intermediate voltage Vbus' provided by the first-stage power conversion circuit 11 has a large transient undershoot. Under the regulation of the first-stage control circuit 14, the first-stage power conversion circuit 11 draws more energy from its input to stabilize the intermediate voltage Vbus′. In this process, the regulation speeds of the first-stage control circuit 14 and the second-stage control circuit 15 affect the stabilization of the intermediate voltage Vbus' and the output voltage Vout greatly.

FIG. 2 shows a schematic diagram of a power conversion system 20 in accordance with an embodiment of the present invention. The power conversion system 20 includes a first-stage power conversion circuit 21, a second-stage power conversion circuit 22, and a control circuit 23. The first-stage power conversion circuit 21 converts the input voltage Vin to an intermediate voltage Vbus (also referred to a first output voltage). The second-stage power conversion circuit 22 converts the intermediate voltage Vbus to the output voltage Vout (also referred to a second output voltage), and provides the output voltage Vout to the load (not shown in FIG. 2).

In the embodiment of FIG. 2, the first-stage power conversion circuit 21 has a BOOST topology, used as a PFC (Power Factor Correction) circuit. The input voltage Vin may have a rectified half-sine wave, which is obtained by rectifying an AC voltage. An input current lin is controlled to follow the waveform of the input voltage Vin, thereby improving the power factor of the first-stage power conversion circuit 21. In the embodiment of FIG. 2, the first-stage power conversion circuit 21 includes an inductor L1, a main switch Q1, a slave switch D1 and an output capacitor Cb. The second-stage power conversion circuit 22 may be an LLC (Inductor-Inductor-Capacitor) circuit. It should be understood that, the first-stage power conversion circuit 21 and the second-stage power conversion circuit 22 may have other topologies, such as BUCK topology, FLYBACK topology, and the like, which depends on the system application.

In the embodiment of FIG. 2, the control circuit 23 includes a compensation control circuit 231, a pre-stage control circuit 232 and a driving circuit 233.

The compensation control circuit 231 receives a first feedback signal Vfb1 and a second feedback signal Vfb2 and provides a compensation control signal Vcomp based on the first feedback signal Vfb1 and the second feedback signal Vfb2. The first feedback signal Vfb1 indicates the intermediate voltage Vbus provided by the first-stage power conversion circuit 21. In the embodiment of FIG. 2, the power conversion system 20 further includes a feedback circuit 24. The feedback circuit 24 is configured to receive the intermediate voltage Vbus and to provide the first feedback signal Vfb1 based on the intermediate voltage Vbus. The feedback circuit 24 may be a voltage dividing circuit, and the first feedback signal Vfb1 may be a voltage dividing signal of the intermediate voltage Vbus. In other embodiments, the feedback circuit 24 may also include an isolation device (e.g., optocoupler) when the first-stage power conversion circuit 21 has other topologies (e.g., isolated FLYBACK topology). In some embodiments, the intermediate voltage Vbus could be provided directly to the control circuit 23 as the first feedback signal Vfb1 if the intermediate voltage Vbus can meet the input requirements of the control circuit 23.

The second feedback signal Vfb2 indicates the output voltage Vout provided by the second-stage power conversion circuit 22. In the embodiment of FIG. 2, the power conversion system 20 further includes a feedback circuit 25. The feedback circuit 25 is configured to receive the output voltage Vout and to provide the second feedback signal Vfb2 based on the output voltage Vout. The feedback circuit 25 may be a voltage dividing circuit, and the second feedback signal Vfb2 may be a voltage dividing signal of the output voltage Vout. In the embodiment of FIG. 2, the second-stage power conversion circuit 22 has an LLC topology, the feedback circuit 25 includes an optocoupler. In some embodiments, the feedback circuit 25 includes an optocoupler and some related devices (e.g., TL431). In some embodiments, the output voltage Vout could also be directly provided to the control circuit 23 as the second feedback signal Vfb2 if the output voltage Vout can meet the input requirements of the control circuit 23. In the embodiment of FIG. 2, the second feedback signal Vfb2 corresponds to a load current Iout. In one embodiment, the second feedback signal Vfb2 is proportional to the load current Iout. In another embodiment, the second feedback signal Vfb2 corresponds to the output voltage Vout and varies with the output voltage Vout.

In the embodiment of FIG. 2, the PFC circuit is shown as an example of the first-stage power conversion circuit 21 to illustrate the working principle of the present invention. Therefore, in the embodiment of FIG. 2, the control circuit 23 is a control circuit of the PFC circuit. As shown in FIG. 2, the pre-stage control circuit 232 receives the compensation control signal Vcomp, a current sense signal Ics and the input voltage Vin, and provides a switching control signal P1 for controlling the main switch Q1 of the first-stage power conversion circuit 21. The current sense signal Ics indicates the input current lin of the first-stage power conversion circuit 21. In one embodiment, the input voltage Vin could be provided to the pre-stage control circuit 232 via a voltage divider.

In other embodiments, the first-stage power conversion circuit 21 has other topologies (e.g., BUCK topology or a conventional BOOST circuit). When the first-stage power conversion circuit 21 receives the input voltage Vin with a fixed value, the input voltage Vin and the input current lin may not be used to control the main switch Q1. In other words, the pre-stage control circuit 232 may provide the switching control signal P1 solely based on the compensating control signal Vcomp.

The driving circuit 233 is used to enhance the driving capability of the switching control signal P1. In the embodiment shown in FIG. 2, a power driving signal VG1, which is provided to a control terminal of the main switch Q1, has the same phase as the switching control signal P1. The difference between the power driving signal VG1 and the switching control signal P1 is the driving capability.

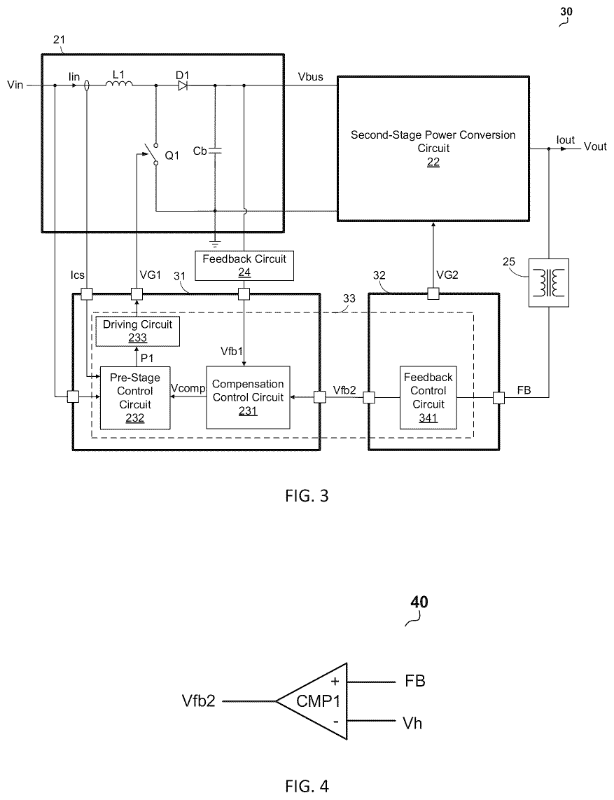

FIG. 3 shows a schematic diagram of a power conversion system 30 in accordance with an embodiment of the present invention. The power conversion system 30 includes the first-stage power conversion circuit 21, the second-stage power conversion circuit 22 and a control circuit 33.

In the embodiment of FIG. 3, the control circuit 33 includes a feedback control circuit 341, the compensation control circuit 231, the pre-stage control circuit 232 and the driving circuit 233.

The feedback control circuit 341 receives a feedback voltage signal FB and provides the second feedback signal Vfb2 based on the feedback voltage signal FB. The feedback voltage signal FB could be a voltage signal provided by the feedback circuit 25 based on the output voltage Vout. In one embodiment, the feedback voltage signal FB corresponds to the output voltage Vout and is proportional to the load current Iout.

The feedback control circuit 341 receives the feedback voltage signal FB and provides the second feedback signal Vfb2 based on the feedback voltage signal FB to indicate the load condition. In one embodiment, when the load increases transiently, the feedback voltage signal FB increases transiently. The second feedback signal Vfb2 may have a first signal state to indicate the load increase. When the load decreases transiently, the feedback voltage signal FB decreases transiently. The second feedback signal Vfb2 may have a second signal state to indicate the load decrease. The first signal state and the second signal state may be pulses having different widths, or pulses with different marks, or pulses with different voltage levels. Different marks correspond to different comparators. In some embodiments, the second feedback signal Vfb2 may be a digital signal including the state information of the feedback voltage signal FB. That is to say, the second feedback signal Vfb2 indicates the change of the output voltage Vout and the load current Iout.

In the embodiment of FIG. 3, the compensation control circuit 231, the pre-stage control circuit 232 and the driving circuit 233 are integrated in a monolithic integrated circuit 31, and the feedback control circuit 341 is integrated in another monolithic integrated circuit 32. The monolithic integrated circuit 31 provides the power driving signal VG1 to control the first-stage power conversion circuit 21. The monolithic integrated circuit 32 provides a power driving signal VG2 to control the second-stage power conversion circuit 22. In other embodiments, the compensation control circuit 231, the pre-stage control circuit 232, the driving circuit 233 and the feedback control circuit 341 are all integrated in a monolithic integrated circuit. In some embodiment, the monolithic integrated circuit 31 and the monolithic integrated circuit 32 are integrated in a same package.

FIG. 4 shows a schematic diagram of a feedback control circuit 40 in accordance with an embodiment of the present invention. As shown in FIG. 4, the feedback control circuit 40 includes an overshoot comparator CMP1. The overshoot comparator CMP1 receives the feedback voltage signal FB and an overshoot threshold Vh and provides the second feedback signal Vfb2 based on the feedback voltage signal FB and the overshoot threshold Vh. When the load increases transiently, the load current Iout increases transiently, the output voltage Vout decreases transiently, the feedback voltage signal FB increases accordingly. When the feedback voltage signal FB increases to the overshoot threshold Vh, the second feedback signal Vfb2 changes from low level to high level, to indicate the load increase.

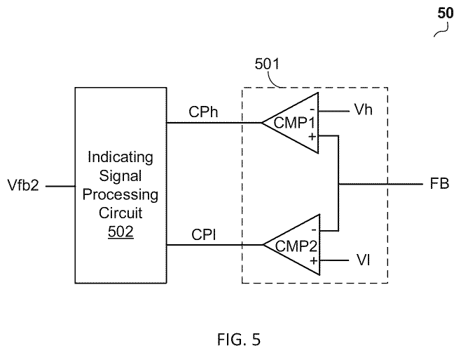

FIG. 5 shows a schematic diagram of a feedback control circuit 50 in accordance with an embodiment of the present invention. As shown in FIG. 5, the feedback control circuit 50 includes a comparing circuit 501 and an indicating signal processing circuit 502. The comparing circuit 501 includes the overshoot comparator CMP1 and an undershoot comparator CMP2. The overshoot comparator CMP1 receives the feedback voltage signal FB and the overshoot threshold Vh and provides an overshoot indicating signal CPh based on the feedback voltage signal FB and the overshoot threshold Vh. The undershoot comparator CMP2 receives the feedback voltage signal FB and an undershoot threshold VI and provides an undershoot indicating signal CPI based on the feedback voltage signal FB and the undershoot threshold VI. The indicating signal processing circuit 502 receives the overshoot indicating signal CPh and the undershoot indicating signal CPI and provides the second feedback signal Vfb2 based on the overshoot indicating signal CPh and the undershoot indicating signal CPI.

In one embodiment, when the load increases transiently, the output voltage Vout decreases transiently, the feedback voltage signal FB increases accordingly. When the feedback voltage signal FB increases to the overshoot threshold Vh, the overshoot indicating signal CPh changes from low level to high level, to indicate the load increase. When the load decreases transiently, the output voltage Vout increases transiently, the feedback voltage signal FB decreases accordingly. When the feedback voltage signal FB decreases to the undershoot threshold VI, the undershoot indicating signal CPI changes from low level to high level, to indicate the load decrease.

The indicating signal processing circuit 502 receives the overshoot indicating signal CPh and the undershoot indicating signal CPI and provides the second feedback signal Vfb2 to indicate whether the feedback voltage signal FB increases to the overshoot threshold Vh or decreases to the undershoot threshold VI.

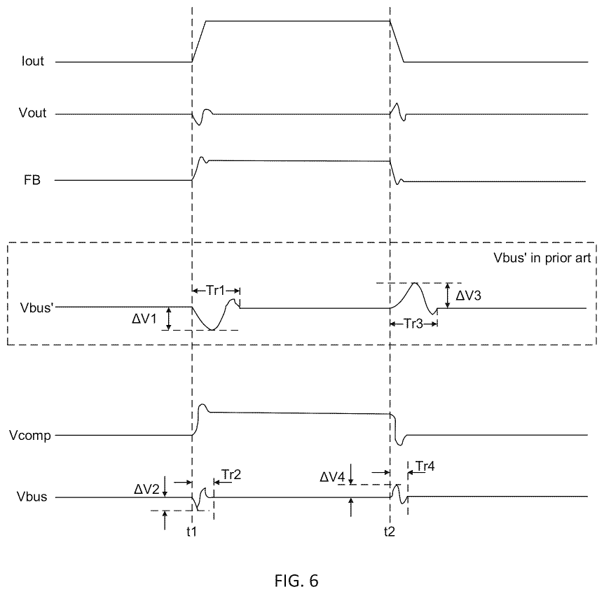

When the feedback control circuit 50 is utilized to the power conversion system 30 of the embodiment of FIG. 3, working waveforms of the power conversion system 30 are shown in FIG. 6. The operation of the power conversion system 30 is specifically described below with reference to FIGS. 3, 5 and 6.

FIG. 6 shows working waveforms of the power conversion system 30 in accordance with an embodiment of the present invention. As shown in FIG. 6, at time t1, the load current Iout increases transiently (i.e., the load increases transiently). At this time, the output voltage Vout decreases and the feedback voltage signal FB increases.

In the conventional two-stage power conversion system 10 shown in FIG. 1, the first-stage control circuit 14 and the second-stage control circuit 15 are independent of each other. Thus, the regulation speed of the entire system is slow, and the intermediate voltage Vbus' has a large undershoot AV1. Furthermore, the intermediate voltage Vbus' has a long regulation time Tr1.

In the embodiment of the present invention, the state of the output voltage Vout is provided directly to the compensation control circuit 231 through the second feedback signal Vfb2. The second feedback signal Vfb2 indicating the output voltage Vout and the first feedback signal Vfb1 indicating the intermediate voltage Vbus are used together to regulate the intermediate voltage Vbus. The compensation control circuit 231 receives the first feedback signal Vfb1 and the second feedback signal Vfb2 and generates the compensation control signal Vcomp based on the first feedback signal Vfb1 and the second feedback signal Vfb2. The pre-stage control circuit 232 receives the compensation control signal Vcomp and generates the switching control signal P1 to control the main switch Q1 based on the compensation control signal Vcomp. Therefore, the intermediate voltage Vbus could be regulated fast. The intermediate voltage Vbus shown in FIG. 6 is provided by the first-stage power conversion circuit 21 of the embodiment of FIG. 3. As shown in FIG. 6, compared to the intermediate voltage Vbus' in the prior art, under the regulation of the control circuit 33, an undershoot AV2 of the intermediate voltage Vbus is significantly reduced and a regulation time Tr2 is also significantly shortened.

Similarly, at time t2, the load current Iout decreases transiently (i.e., the load decreases transiently). At this time, the output voltage Vout increases and the feedback voltage signal FB decreases.

In the conventional two-stage power conversion system 10 as shown in FIG. 1, the first-stage control circuit 14 and the second-stage control circuit 15 are independent of each other. Thus, the regulation speed of the entire system is slow, and the intermediate voltage Vbus' has a large overshoot AV3. Furthermore, the intermediate voltage Vbus' has a long regulation time Tr3.

In the embodiment of the present invention, the second feedback signal Vfb2 indicating the output voltage Vout and the first feedback signal Vfb1 indicating the intermediate voltage Vbus are used together to regulate the intermediate voltage Vbus. The compensation control circuit 231 receives the first feedback signal Vfb1 and the second feedback signal Vfb2 and generates the compensation control signal Vcomp based on the first feedback signal Vfb1 and the second feedback signal Vfb2. The pre-stage control circuit 232 receives the compensation control signal Vcomp and generates the switching control signal P1 to control the main switch Q1 based on the compensation control signal Vcomp. Therefore, the intermediate voltage Vbus could be regulated fast. As shown in FIG. 6, compared to the intermediate voltage Vbus' in the prior art, under the regulation of the control circuit 33, an overshoot AV4 of the intermediate voltage Vbus is significantly reduced and a regulation time Tr4 is also significantly shortened.

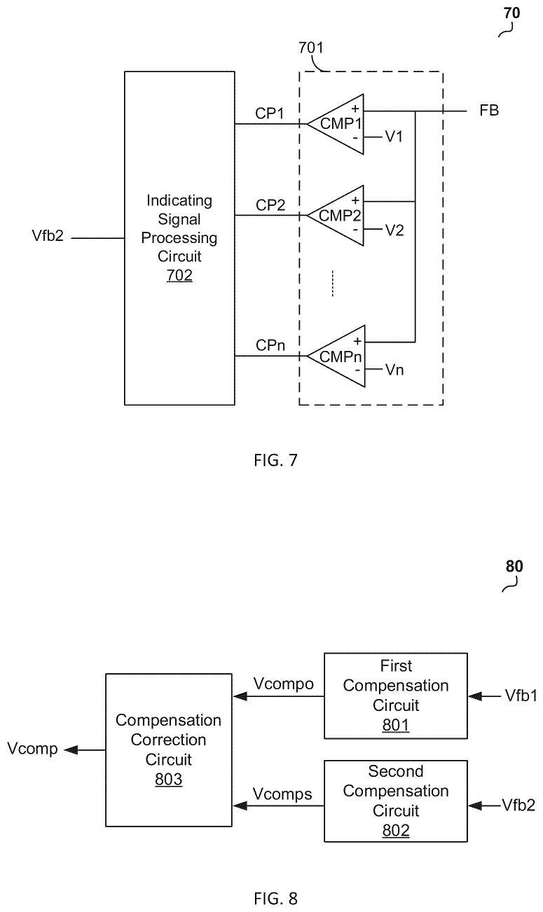

FIG. 7 shows a schematic diagram of a feedback control circuit 70 in accordance with an embodiment of the present invention. As shown in FIG. 7, the feedback control circuit 70 includes a comparing circuit 701 and an indicating signal processing circuit 702. The comparing circuit 701 includes a plurality of comparators CMP1˜CMPn. Each of the plurality of comparators CMPk receives the feedback voltage signal FB and a corresponding reference signal Vk and provides a corresponding comparison signal CPk based on a comparison result of the feedback voltage signal FB and the corresponding reference signal Vk, wherein n is a natural number greater than 1, k is a number between 1 and n. Based on the comparison signals CP1-CPn, the indicating signal processing circuit 702 determines a segment the feedback voltage signal FB belongs to and provides the second feedback signal Vfb2 to indicate the feedback voltage signal FB. In other words, the second feedback signal Vfb2 corresponds to a voltage segment the output voltage Vout belongs to and the state of the load current Iout. In some embodiments, the second feedback signal Vfb2 may have different signal states to indicate the output voltage Vout and the load current Iout. In other embodiment, the second feedback signal Vfb2 may be pulse signals with different marks (to distinguish different comparators). In one embodiment, the second feedback signal Vfb2 may be a digital signal including the information of the output voltage Vout.

FIG. 8 shows a schematic diagram of a compensation control circuit 80 in accordance with an embodiment of the present invention. As shown in FIG. 8, the compensation control circuit 80 includes a first compensation circuit 801, a second compensation circuit 802 and a compensation correction circuit 803. The first compensation circuit 801 provides a first compensation signal Vcompo based on the first feedback signal Vfb1. The first compensation circuit 801 could be a conventional compensation circuit for the control loop of the PFC circuit. The second compensation circuit 802 provides a second compensation signal Vcomps based on the second feedback signal Vfb2. The compensation correction circuit 803 provides the compensation control signal Vcomp based on the first compensation signal Vcompo and the second compensation signal Vcomps.

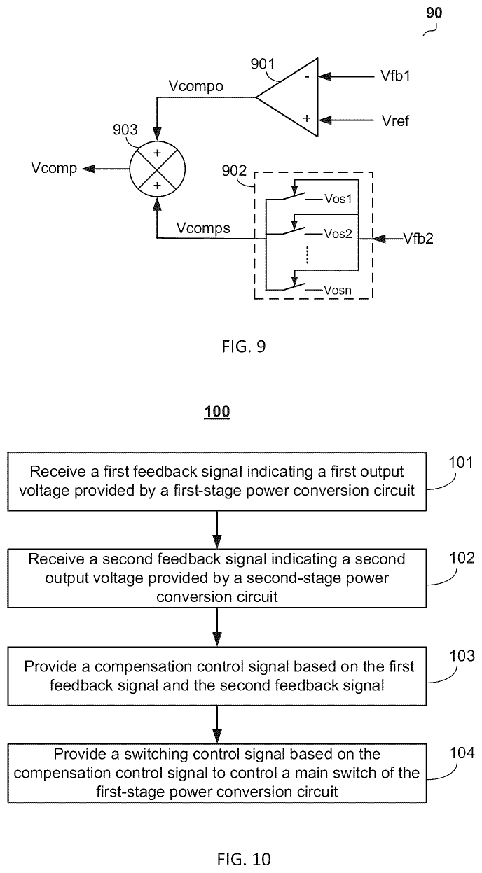

FIG. 9 shows a schematic diagram of a compensation control circuit 90 in accordance with an embodiment of the present invention.

As shown in FIG. 9, the compensation control circuit 90 includes a first compensation circuit 901, a second compensation circuit 902 and a compensation correction circuit 903. The first compensation circuit 901 includes an error amplifying circuit. The error amplifying circuit receives the first feedback signal Vfb1 and a first reference signal Vref and provides the first compensation signal Vcompo based on the first feedback signal Vfb1 and the first reference signal Vref. In some embodiments, the first compensation circuit 901 may also be realized by a digital feedback circuit commonly used in the art. The second compensation circuit 902 includes a selecting circuit. The selecting circuit provides the second compensation signal Vcomps by selecting one of a plurality of compensation values Vos1˜Vosn based on the second feedback signal Vfb2. In one embodiment, when the second feedback signal Vfb2 indicates that the output voltage Vout decreases to a first voltage, the second compensation signal Vcomps has a first compensation value Vos1. When the second feedback signal Vfb2 indicates that the output voltage Vout decreases to a second voltage, the second compensation signal Vcomps has a second compensation value Vos2, and so on. The first voltage is higher than the second voltage, the first compensation value Vos1 is smaller than the second compensation value Vos2. In other words, the greater the decreasing of the output voltage Vout, the greater the increasing of the feedback voltage signal FB, the greater the second compensation signal Vcomps. In other embodiments, the second compensation circuit 902 may also be realized by other circuits. For example, the second compensation circuit 902 may be a look-up table circuit or a storage circuit having the plurality of compensation values. The second compensation circuit 902 provides the second compensation signal Vcomps by selecting one of the plurality of compensation values based on the second feedback signal Vfb2. The compensation correction circuit 903 includes an adding circuit to perform addition on the first compensation signal Vcompo and the second compensation signal Vcomps, to provide the compensation control signal Vcomp.

It should be understood that, the compensation correction circuit 903 could be different calculating circuits depending on the relationship between the compensation control signal Vcomp and the switching control signal P1. For example, in some embodiments, the larger the compensation control signal Vcomp is, the smaller the duty cycle of the switching control signal P1 is, the less energy the first-stage power conversion circuit 21 is transferred from the input to the output in a single switching cycle. In that case, the compensation correction circuit 903 is a subtracting circuit.

In some embodiments, the duty cycle of the switching control signal P1 is regulated by a calculating result, which is obtained by performing calculation based on the compensation control signal Vcomp and a corresponding compensation reference signal. In these embodiments, the corresponding compensation reference signal could be regulated by the second compensation signal Vcomps, since regulating the compensation reference signal is equivalent to regulating the compensation control signal Vcomp. When the first-stage power conversion circuit 21 employs the PFC circuit, as shown in FIG. 3, the compensation reference signal is associated with the input voltage Vin and the current sense signals Ics indicating the input current lin.

FIG. 10 shows a flow diagram of a control method 100 for a power conversion system in accordance with an embodiment of the present invention. The power conversion system may be the power conversion system 20 or the power conversion system 30 in the aforementioned embodiments, having the first-stage power conversion circuit 21 and the second-stage power conversion circuit 22. The control method includes steps 101˜104.

At step 101, a first feedback signal indicating a first output voltage provided by a first-stage power conversion circuit is received.

At step 102, a second feedback signal indicating a second output voltage provided by a second-stage power conversion circuit is received.

At step 103, a compensation control signal is provided based on the first feedback signal and the second feedback signal.

At step 104, a switching control signal is provided based on the compensation control signal to control a main switch of the first-stage power conversion circuit.

The steps 101˜104 could be performed in different orders.

In one embodiment, the second feedback signal indicates a value of a load current of the power conversion system.

In one embodiment, the second feedback signal corresponds to a voltage segment the second output voltage belongs to.

In one embodiment, the step 103 includes the following steps. A first compensation signal is provided based on the first feedback signal. A second compensation signal is provided based on the second feedback signal. The compensation control signal is provided by performing calculation based on the first compensation signal and the second compensation signal.

In one embodiment, the step of providing the first compensation signal based on the first feedback signal includes the following step. The first compensation signal is provided based on an error amplifying result of the first feedback signal and a first reference signal.

In one embodiment, the step of providing the second compensation signal based on the second feedback signal includes the following steps. A plurality of compensation values is set. One of the plurality of compensation values is selected as the second compensation signal based on the second feedback signal.

It should be understood, the circuit and the workflow described in the present invention are just for schematic illustration. Any circuit can realize the function and operation of the present invention does not depart from the spirit and the scope of the invention.

While specific embodiments of the present invention have been provided, it is to be understood that these embodiments are for illustration purposes and not limiting. Since the invention can be practiced in various forms without distracting the spirit or the substance of the invention. It should be appreciated that the above embodiments are not confined to any aforementioned specific detail but should be explanatory broadly within the spirit and scope limited by the appended claims. Thus, all the variations and modification falling into the scope of the claims and their equivalents should be covered by the appended claims.

What is claimed is:

1. A control circuit for a power conversion system having a first-stage power conversion circuit and a second-stage power conversion circuit, the control circuit comprising:
a compensation control circuit configured to receive a first feedback signal and a second feedback signal, and to provide a compensation control signal based on the first feedback signal and the second feedback signal, wherein the first feedback signal indicates a first output voltage provided by the first-stage power conversion circuit, the second feedback signal indicates a second output voltage provided by the second-stage power conversion circuit; and
a pre-stage control circuit configured to receive the compensation control signal and to provide a switching control signal based on the compensation control signal, wherein the switching control signal is configured to control a main switch of the first-stage power conversion circuit.

2. The control circuit of claim 1, wherein the compensation control circuit comprises:
a first compensation circuit configured to receive the first feedback signal and a first reference signal and to provide a first compensation signal based on the first feedback signal and the first reference signal;
a second compensation circuit configured to receive the second feedback signal and to provide a second compensation signal based on the second feedback signal; and
a compensation correction circuit configured to receive the first compensation signal and the second compensation signal and to provide the compensation control signal based on the first compensation signal and the second compensation signal.

3. The control circuit of claim 2, wherein the second compensation circuit comprises a selecting circuit configured to provide the second compensation signal by selecting one of a plurality of compensation values based on the second feedback signal.

4. The control circuit of claim 2, wherein the compensation correction circuit comprises:
a calculating circuit configured to perform calculation based on the first compensation signal and the second compensation signal and to provide the compensation control signal based on the calculation.

5. The control circuit of claim 1, wherein the second feedback signal is proportional to a value of a load current of the power conversion system.

6. The control circuit of claim 1, further comprising:
a feedback control circuit configured to receive a feedback voltage signal and to provide the second feedback signal based on the feedback voltage signal, wherein the feedback voltage signal is generated based on the second output voltage.

7. The control circuit of claim 6, wherein the feedback control circuit comprises:
an overshoot comparator configured to receive the feedback voltage signal and an overshoot threshold and to provide the second feedback signal based on the feedback voltage signal and the overshoot threshold.

8. The control circuit of claim 6, wherein the feedback control circuit comprises:
an undershoot comparator configured to receive the feedback voltage signal and an undershoot threshold and to provide an undershoot indicating signal based on the feedback voltage signal and the undershoot threshold;
an overshoot comparator configured to receive the feedback voltage signal and an overshoot threshold and to provide an overshoot indicating signal based on the feedback voltage signal and the overshoot threshold; and
an indicating signal processing circuit configured to receive the overshoot indicating signal and the undershoot indicating signal and to provide the second feedback signal based on the overshoot indicating signal and the undershoot indicating signal.

9. The control circuit of claim 6, wherein the feedback control circuit comprises:
a plurality of comparators, wherein each of the plurality of comparators is configured to receive the feedback voltage signal and a corresponding reference signal and to provide a corresponding comparison signal; and
an indicating signal processing circuit configured to receive the comparison signals provided by the plurality of comparators and to provide the second feedback signal based on the comparison signals.

10. A power conversion system, comprising:
a first-stage power conversion circuit configured to receive an input voltage and to provide a first output voltage based on the input voltage;
a second-stage power conversion circuit configured to receive the first output voltage and to provide a second output voltage based on the first output voltage; and
a control circuit, comprising:
a compensation control circuit configured to receive a first feedback signal indicating the first output voltage and a second feedback signal indicating the second output voltage, and to provide a compensation control signal based on the first feedback signal and the second feedback signal; and
a pre-stage control circuit configured to receive the compensation control signal and to provide a switching control signal based on the compensation control signal, wherein the switching control signal is configured to control a main switch of the first-stage power conversion circuit.

11. The power conversion system of claim 10, wherein the compensation control circuit comprises:
a first compensation circuit configured to receive the first feedback signal and a first reference signal and to provide a first compensation signal based on the first feedback signal and the first reference signal;
a second compensation circuit configured to receive the second feedback signal and to provide a second compensation signal based on the second feedback signal; and
a compensation correction circuit configured to receive the first compensation signal and the second compensation signal, and to provide the compensation control signal based on the first compensation signal and the second compensation signal.

12. The power conversion system of claim 11, wherein the second compensation circuit comprises a selecting circuit configured to provide the second compensation signal by selecting one of a plurality of compensation values based on the second feedback signal.

13. The power conversion system of claim 11, wherein the compensation correction circuit comprises:
a calculating circuit configured to perform calculation based on the first compensation signal and the second compensation signal and to provide the compensation control signal based on the calculation.

14. The power conversion system of claim 10, further comprising:
a feedback circuit configured to receive the second output voltage and to provide a feedback voltage signal based on the second output voltage, wherein the feedback circuit comprises an optocoupler.

15. A control method for a power conversion system having a first-stage power conversion circuit and a second-stage power conversion circuit, comprising:
receiving a first feedback signal indicating a first output voltage provided by the first-stage power conversion circuit;
receiving a second feedback signal indicating a second output voltage provided by the second-stage power conversion circuit;
providing a compensation control signal based on the first feedback signal and the second feedback signal; and
providing a switching control signal based on the compensation control signal to control a main switch of the first-stage power conversion circuit.

16. The control method of claim 15, wherein the second feedback signal indicates a value of a load current of the power conversion system.

17. The control method of claim 15, wherein the second feedback signal corresponds to a voltage segment the second output voltage belongs to.

18. The control method of claim 15, wherein the step of providing the compensation control signal based on the first feedback signal and the second feedback signal comprises:
providing a first compensation signal based on the first feedback signal;
providing a second compensation signal based on the second feedback signal; and
performing calculation based on the first feedback signal and the second feedback signal to provide the compensation control signal.

19. The control method of claim 18, wherein the step of providing the first compensation signal based on the first feedback signal comprises:
providing the first compensation signal based on an error amplifying result of the first feedback signal and a first reference signal.

20. The control method of claim 18, wherein the step of providing the second compensation signal based on the second feedback signal comprises:
setting a plurality of compensation values; and
selecting one of the plurality of compensation values as the second compensation signal based on the second feedback signal.
